(19) United States
(12) Patent Application Publication
(10) Pub. No.: US 2003/0133566 A1
(43) Pub. Date: Jul. 17, 2003

(54) Public key encryption system

(76) Inventor: David Soldera, Bristol (GB)

Correspondence Address: HEWLETT-PACKARD COMPANY, Intellectual Property Administration, P.O. Box 272400, Fort Collins, CA, 80527-2400, US

(21) Appl. No.: 10/083,762

(22) Filed: Feb. 25, 2002

(30) Foreign Application Priority Data
Jan. 9, 2002 (GB) 0200367.1

(51) Int. Cl. H04L 9/00

(52) U.S. Cl. 380/30

(57) ABSTRACT

This invention relates to a variant of the El-Gamal public key encryption scheme, which is provably secure against an adaptively chosen ciphertext adversary using standard public-key cryptography assumptions i.e. not the random oracle model. This new scheme has roughly half the computational overhead and similar communication overhead as the scheme by Cramer-Shoup.

This invention relates to a public key encryption scheme and to a method of encrypting and/or decrypting using public key encryption.

In 1998 Cramer-Shoup (CS) (Cramer, R. and Shoup, V. A practical public key cryptosystem provably secure against adaptive chosen ciphertext attack. CRYPTO'98. LNCS 1462, pg 13-25. Springer-Verlag, California, 1998) presented a new El-Gamal style (El-Gamal, T. A public key cryptosystem and signature scheme based on discrete logarithms. IEEE Trans. Inform. Theory, 31, pg 469-472, 1985) public key encryption scheme that was the first efficient and provably secure scheme based solely on standard intractability assumptions. The contribution of CS was their scheme was efficient and yet did not rely on the random oracle (RO) assumption (see Bellare, M. and Rogaway, P. Optimal asymmetric encryption—how to encrypt with RSA.EUROCRYTP'94. LNCS 950, pg 92-111. Springer-Verlag, 1994 for more information on random oracles). However, schemes that rely on the RO model, are still more efficient than the CS scheme. Recent improvements to CS (see for example Shoup, V. Using hash functions as a hedge against chosen ciphertext attack. EUROCRYPT'00. LNCS 1807, pg 275-288. Springer-Verlag, 2000 (this is actually a key encapsulation scheme)) have increased its efficiency, but not to the point where it can compete with the best RO schemes.

Using the RO model or standard assumptions for a proof of security, represent opposite ends of the provable security spectrum. The RO model yields extremely efficient (see Bellare above) schemes yet practical implementations using hash functions cannot hope to achieve actual RO's. At the other end of the spectrum are the standard intractability assumptions, they give us much more confidence in security, yet the schemes that are available are still too inefficient (at least compared to RO schemes) for the majority of practical implementations.

It is an object of the present invention to address the above disadvantages to seek to provide a cryptosystem having more practical implementation together with more provable security.

According to a first aspect of the present invention a public key encryption scheme using a private key, z, and a public key, h, comprises the encryption of a message, m, within a ciphertext, wherein an element of the encrypted ciphertext containing the message is formed by a message product of a variable, ε, based on the public key, h, and an output of an invertible deterministic method, π, operated on at least the message, m, and a hash, H, of at least the message.

The ciphertext preferably includes at least one random element, u₁.

Preferably, the invertible deterministic method is operated on the message, m, an index, j, of the hash and a hash, H, over both the message, m, and at least one random element, u₁, preferably two random elements u₁, u₂.

The variable, ε, based on the public key is preferably the public key, h, raised to the power of a random number, r.

The ciphertext may be decrypted using a private key, z, the at least one random element u₁, the message product, and the invertible deterministic method, π.

The invertible deterministic method, π, may be operated on a check for the decryption. The check may be the hash, H, over at least the message, m. Preferably, the hash, H, for the check is over the message and at least one random element, u₁.

Preferably, the message product is represented by ε.M, where ε=h^{r} (r is random) and h=g₁^{z}, where g₁ is a first generator, z is a randomly chosen private key and M=π (m, j, t) where π is the invertible deterministic method, m is the message, j is a random index of the hash and t=Hⱼ (m, g₁^{r}, g₂^{r}), where Hⱼ is the j^{th} hash and g₂ is a second generator.

The invertible deterministic method may be a squaring.

The ciphertext preferably includes said at least on random element, u₁, preferably both random elements, u₁, u₂.

At least one of said random elements, u₁, is preferably used to decipher the ciphertext, in conjunction with the private key, z, to determine the output, M, of the invertible deterministic method, π, which output is then preferably inverted to give an original input and hence the message, m.

According to a second aspect of the present invention a public key encryption/decryption method makes use of a ciphertext that includes a check element, t, wherein a check made during decryption is a hash, H, over at least the encrypted message, m.

Preferably, the hash, H, is over the message, m, and at least one random element, u₁, preferably two random elements, u₁, u₂.

The invention thereby advantageously relies on the collision-free aspects of a hash. The hash may be SHA-1.

According to a third aspect of the present invention a public key encryption method includes creating a ciphertext requiring at most 4 exponentiations to encrypt, including exponentiations for each of at least two random elements, u₁, u₂ and an exponentiation for a public key, h, wherein a message for encryption does not require an exponentiation to encrypt.

The method preferably includes 3 exponentiations, being for a first random element, u₁, a second random element, u₂, and for the public key, h.

The method advantageously requires fewer exponentiations than previous methods, whilst still being provably secure, thus having a significantly lower computational overhead compared to previous methods.

According to a fourth aspect of the invention a public key decryption method includes decrypting a ciphertext with at most 2 exponentiations, including an exponentiation using a private key, z, to allow recovery of an encrypted message, m.

Preferably, only one exponentiation is required.

The method advantageously requires fewer exponentiations than existing methods, whilst still being provably secure. Thus there is a significantly lower computational overhead involved in decryption.

According to a fifth aspect of the invention a public key encryption/decryption method involves creating a ciphertext and decrypting the ciphertext, in which a public key requires no more than 3 group elements and a private key requires no more than one group element, whilst still providing a provably secure method.

The invention extends to a message encrypted according to any one of the previous aspects.

The invention extends to a recordable medium bearing a ciphertext encrypting a message encrypted according to the previous aspects.

The invention extends to a computer operable to perform any of the previous aspects.

The invention extends to a recordable medium bearing a computer program operable to perform any of the above aspects.

All of the features described herein may be combined with any of the aspects or parts of the invention as set out above.

A specific embodiment of the present invention will now be described with reference to the accompanying drawing, in which:

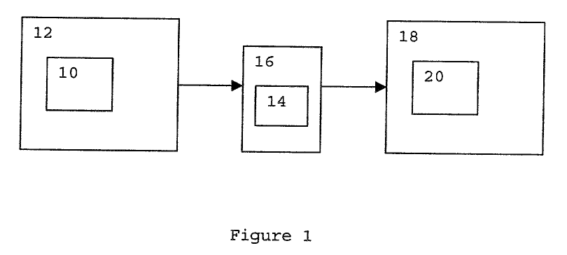

FIG. 1 is a schematic diagram of the encryption and decryption of a message.

Below is described a new public key encryption scheme, which starts to bridge the gap (discussed in the introduction above) in efficiencies of practical implementation of such encryption, while still having its security rely solely on standard intractability assumptions. Compared to the CS scheme mentioned above, this new scheme has a similar communication overhead but requires only 4 exponentiations in total (for both encryption and decryption) compared to 8 for the most efficient (pure public key) version of CS. In terms of offline storage, if CS and the new scheme are used in the same group, then CS requires 5 group elements to represent its public key and 5 for its private, whereas the new scheme requires 3 for its public key and 1 for its private. Thus the contribution of this invention is to present a provably secure public key encryption scheme based on standard intractability assumptions, where the efficiency of the scheme rivals those schemes that rely on the random oracle model.

FIG. 1 shows an encryption module 10, which forms part of a first computer 12. The encryption module 10 operates a computer program to encrypt a message 14 in a ciphertext 16. The message 14 encrypted in the ciphertext 16 is then transmitted or passed to a third party for decryption with a computer program running on a decryption module 18 of a second computer 20.

The implementation of the method described herein is applicable to all types of public key encryption already in use, for example the transmission of messages and data securely over computer networks, either local networks or global networks (such as the internet). The method can be used as a computer program and operated on a message to be encrypted and then decrypted by a user with the relevant key, as is well known in the art.

1.1 Notation

We use standard notations and conventions for writing probabilistic algorithms and experiments. If A is a probabilistic algorithm, than A(x₁, x₂, . . . ; r) is the result of running A on inputs x₁, x₂, . . . and coins r. We let y←A(x₁, x₂, . . . ) denote the experiment of picking r at random and letting y be A(x₁, x₂, . . . ; r). If S is a finite set then x←S (or x∈_{R} S) is the operation of picking an element uniformly from S.

If b is a bit then \overline{b} is its complement. {0,1}* is a binary string of arbitrary length and {0,1}^{l} is a binary string of length l. The length of a string x is denoted by |x|, and the concatenation of strings x and y is denoted by x∥y. The ith bit of x is denoted by xᵢ and the substring of x from xᵢ to xⱼ, where i≦j, is denoted by x_{[i]}. A function ƒ: [symbol] → [symbol] is negligible if for every constant c≧0 there exists an integer k_{c} such that ƒ(k)≦k^{-c} for all k≧k_{c}.

1.2 Definitions

Industinguishability of encryptions against an adaptive chosen ciphertext (IND-CCA2) adversary is the standard accepted notion of security for a public key encryption scheme. The basic idea behind an IND-CCA2 adversary is they are given access to an encryption and decryption oracle, they then choose two messages, one of which gets encrypted (they do not know which). They are then presented with the ciphertext of the encrypted message and asked to determine which of the two messages was encrypted. They must succeed with probability non-negligibly better than ½. The only restriction is the adversary may not query the decryption oracle with the challenge ciphertext.

We consider the adversary A as running in two stages, a ‘find’ stage and a ‘guess’ stage. The find stage is responsible for finding the pair of messages (it will also output some state information s) and the guess stage is responsible for determining which message was encrypted in the challenge ciphertext.

A formal definition of IND for any type of attack is given in Definition 1, but for a more complete treatise on this area see Bellare, M., Desai, A., Pointcheval, D., and Rogaway, P. Relations among notions of security for public-key encryption schemes. CRYPTO'98. LNCS 1462, pg 26-45. Springer-Verlag, California, 1998. For example other types of attack are CPA and CCAI, see below for definitions. In the definition [symbol] (•) is a probabilistic key generation algorithm, [symbol] (•) is a probabilistic encryption algorithm, [symbol] (•) is a deterministic decryption algorithm and [symbol] (•) is an oracle. The public and secret key are represented by pk and sk, respectively.

Definition 1 [IND-CPA, IND-CCA1, IND-CCA2] Let Π= [symbol] [symbol] [symbol] be an encryption scheme and let A be an adversary. For atk∈{cpa, cca1, cca2} and k∈ [symbol] let Advantage_{A,Π}^{ind-atk}(k)=2·Pr[pk,sk)← [symbol] (1^{k}); (x₀,x₁,s)←A^{O}^{₁}(find, pk); b←{0,1};

y← [symbol] ₚₖ(x_{b}): A^{O}^{₂} (guess,x₀,x₁,s,y)=b]−1

where

| If atk = cpa then O₁(.) = null and O₂ (.) = null | |
|---|---|
| If atk = cca1 then O₁(.) = Dₛₖ(.) | and O₂(.) = null |
| If atk = cca2 then O₁(.) = Dₛₖ(.) | and O₂(.) = Dₛₖ(.) |

It is insisted that A(find, •) outputs x₀, x₁ with |x₀|=|x₁|. In the case of CCA2, it also insisted that A(guess, •) does not ask its oracle to decrypt y. We say that Π is secure in the sense of IND-ATK if A being polynomial-time implies that Advantage_{A.Π}^{ind-atk}(•) is negligible.

2 The Basic Scheme

We encrypt messages m∈{0,1}^{n-2k} and also require a hash function Hⱼ: {0,1}^{*}→{0,1}^{k} chosen from a family of universal one-way hash functions indexed by j. All operations are performed in the group G of order q (q is a large prime) in which there exists two generators g₁ and g₂. There also exists some (invertible) deterministic method π(•) to encode a message as an element of G.

The private key is a randomly chosen z∈Z_{q} and the public key is h=g₁^{z}.

Encryption. We choose r∈_{R} Z_{q}, j∈_{R} Z₂ₖ and compute ε=h^{r}, t=Hⱼ(m, g₁^{r}, g₂^{r}) and M=π(m, j, t). The ciphertext is then

(u₁, u₂, e)=(g₁^{r}, g₂^{r}, ε·M)

Decryption. To decrypt (u₁, u₂, e) we compute ε=u₁^{z},

$$M = \frac{e}{ϵ}$$

and recover the message from m, j, t=π⁻¹(M). Finally we check

t=Hⱼ(m, u₁, u₂)

If this holds we accept the message otherwise we reject.

If the group G is chosen to be the set of quadratic residues a possible encoding method π(•) would be simple squaring (given m∥j∥t was interpreted as an element of Zₚ modulo a large prime p of the form 2q+1). Then in step 2 of the decryption, if neither square root yields a correct hash then the output is also Ø.

The scheme described above has significant advantages over the Cramer Shoup (CS) scheme because the number of exponentiations (a good guide to computational overhead) is only three in the encryption (ε=h^{r}, g₁^{r}, and g₂^{r}), whereas in CS 5 exponentiations are required (g₁^{r}, g₂^{r}, e=h^{r}m and v=c^{r}d^{rα}.

In decryption the present scheme requires one exponentiation for decryption (ε=u₁^{z}), whereas CS requires three (u₁^{z}, u₁^{x}^{₁}^{+y}^{₁}^{α}, and u₂^{x}^{₂}^{+y}^{₂}^{α})

Consequently, the present scheme requires four exponentiations whereas CS requires eight to encrypt and decrypt; this represents a halving in the computational overhead of the present scheme when compared to CS.

In addition, the security is provable (see below) in the present scheme to a level that is comfortably within the definition of negligible.

In the present scheme reliance is made on the collision free properties of the hash function to provide the check. CS uses a hash in the check (two times in fact), but it is within the complex checking equation u₁^{x}^{₁}^{+y}^{₁}^{α}u₂^{x}^{₂}^{+y}^{₂}^{α}=v. A hash function on M, u₁ and u₂ in the present scheme provides greater simplicity with good security and a computational overhead benefit, as discussed above.

In the following a proof of security is given. Although such a proof is beneficial it is not necessary to have the proof to implement the scheme; it is merely a confirmation of the security given by the scheme.

3 Proof of Security

3.1 DDHP

All the proofs rely on the difficulty of the Decision Diffie-Hellman Problem (DDHP), the definition of which, from Cramer, R. and Shoup, V. A practical public key cryptosystem provably secure against adaptive chosen ciphertext attack. CRYPTO'98. LNCS 1462, pg 13-25. Springer-Verlag, California, 1998 is given below.

Definition 2—[Cramer Shoup (above), pg. 16] Let G be a group of large prime order q, and consider the following two distributions:

the distribution R of random quadruples (g₁, g₂, u₁, u₂)∈G⁴;

the distribution D of quadruples (g₁, g₂, u₁, u₂)∈G⁴, where g₁, g₂ are random, and u₁=g₁^{r} and u₂=g₂^{r} for random r∈ [symbol] _{q}.

An algorithm that solves the DDHP is a statistical test that can effectively distinguish these two distributions.

3.2 The Full Scheme

We will prove the security of the basic scheme by proving the security of an equivalent cryptosystem; a ‘full’ version of the basic scheme, this is presented below.

The full scheme encrypts messages m∈{0,1}^{n-2k} and requires a hash function Hⱼ: {0,1}^{*}→{0,1}^{k} chosen from a family of universal one-way hash functions indexed by j. All operations are performed in the group G of order q (q is a large prime) in which there exists two generators g₁ and g₂. There also exists some (invertible) deterministic method π(•) to encode a message as an element of G.

The private key is two randomly chosen elements z₁, z₂∈Z_{q} and the public key is h=g₁^{z}^{₁}g₂^{z}^{₂}.

Encryption. We choose r∈_{R} Z_{q}, j∈_{R} Zₖ and compute ε=h^{r}, t=Hⱼ(m, u₁, u₂) and M=π(m, j, t). The ciphertext is then

(u₁, u₂, e)=(g₁^{r}, g₂^{r}, ε·M)

Decryption. To decrypt (u₁, u₂, e) we compute ε=u₁^{z}^{₁}u₂^{z}^{₂},

$$M = \frac{e}{ϵ}$$

and recover the message from m, j, t=π⁻¹(M). Finally we check

t=Hⱼ(m, u₁, u₂)

If this holds we accept the message otherwise we reject.

3.3 Reducing the Full Scheme to the Basic Scheme

We show that the security of the fill scheme implies the security of the basic scheme. Let B be an IND-CCA2 adversary with an advantage in breaking the basic scheme. We will use B to construct an IND-CCA2 adversary A with an advantage in breaking the full scheme. The basic idea behind this reduction is that B will be given a public key of the form g₁^{z}^{₁}g₂^{z}^{₂}, instead of g₁^{z}, but B will not be able to tell the difference and this allows A to use B's advantage.

We now define adversary A. A can run in two stages, a ‘find’ stage and a ‘guess’ stage. The find stage is responsible for finding a pair of messages to distinguish (it will also output some state information s) and the guess stage is responsible for distinguishing which message was encrypted in the challenge ciphertext. Let [symbol] _{A}(•) be the decryption oracle that A has access too.

Algorithm A(find, g₁, g₂, h, q, G)

Run B(find, g₁, g₂, h, q, G)

When B makes a decryption query, y′, respond with

m ← D_{A}( y′)

B returns (m₀, m₁, s)

A returns (m₀, m_{1, s)}
Algorithm A(guess, m₀, m₁, s, y)

Run B(guess, m₀, m₁, s, y)

When B makes a decryption query, y′ respond with

m ←D_{A}( y′)

B returns b′

A returns b′

Any valid ciphertext that B produces will be of the form (u₁, u₂,(g₁^{z}^{₁}g₂^{z}^{₂})^{r}M) since B encrypts with public key h=g₁^{z}^{₁}g₂^{z}^{₂} hence any valid ciphertexts can be passed to [symbol] _{A}(•) and will be correctly decrypted. It follows that if B has an advantage then so does A.

3.4 The Hash Function

We shall recall some results from Carter, J. L., Wegman, M. N. Universal Classes of Hash Functions. Journal of Computer and System Sciences, 18, 143-154 (1979) about universal hash functions.

Let all hash functions map a set [symbol] into a set [symbol] (and assume [symbol] > [symbol] ). If H is a hash function and x, y∈A, we define

| | | |
|---|---|---|
| δ_{H}(x,y) = | 1 | if x ≠ y and H(x) = H(y) |
| | {open oversize brace} | |
| | 0 | otherwise |

If δ_{H}(x, y)=1, then we say x and y collide under H.

Let [symbol] be a class of functions from [symbol] to [symbol] . We say that [symbol] is universal₂ (the subscript indicates pairs) if for all x, y in [symbol] , δ_{H}(x, y)≦ [symbol] / [symbol] . That is, [symbol] is universal₂ if no pair of distinct keys collide under more than (1/ [symbol] )th of the functions.

We will now recall the proposition from [Wegman and Cater] that we require for this paper.

Proposition [Wegman and Cater (above), pg146]—Let x be any element of [symbol] and [symbol] any subset of [symbol] . Let H be a function chosen randomly from a universal₂ class of functions (with equal probabilities on the functions). Then the mean value of δ_{H}(x, y) ≦ [symbol] / [symbol] .

Hence in this paper we are careful to use a hash function that is randomly selected from a class of universal one-way hash functions, thus making the probability of finding a collision, in the absence of any other information, 1/ [symbol] .

Of course for the sake of correctness of the proof of security a universal one-way hash function should be used, but practical security is unlikely to be compromised by the use of more ‘off-the-shelf’ hash functions like SHA-1, and so these could be used in an implementation of the scheme.

3.5 Sketch of the Proof of Security

Now we show that the full scheme is secure against an IND-CCA2 adversary. First we give the construction of the proof (which is the same as that of CS). It is assumed there exists an adversary A that can break the full scheme in the IND-CCA2 sense and then we show how this adversary can unwittingly be used to help solve what is considered a computationally unfeasible problem, in this case the DDHP.

The proof requires the construction of a simulator. Quadruples from either D or R (but not both) are input to the simulator, which is then responsible for, the creation of keys, simulation of an encryption oracle and simulation of a decryption oracle. The adversary receives all its information, including oracle queries, from the simulator.

The proof runs as follows. A quadruple is input and the simulator creates a valid secret key and public key. The simulator runs the find stage of A, and A returns two messages, m₀ and m₁. The simulator then runs the simulated encryption oracle which chooses a random bit b∈{0, 1}, encrypts Mb and outputs the challenge ciphertext. The adversary cannot see the simulated encryption oracle's choice for b.

The simulator then inputs the challenge ciphertext to the guess stage of the A, and A outputs its guess, b′, for the random bit. Both the simulator and the adversary pass b and b′ respectively to a distinguisher that outputs 1 if b=b′ otherwise 0.

When the input quadruple comes from R, the adversary A cannot succeed in guessing b with any advantage. Alternatively, when the input comes from D, then the simulator creates a perfectly valid ciphertext and A can guess the bit b with its advantage.

Hence by observing the distribution of 0's and 1's that are output by the distinguisher, it can be determined which distribution the quadruples are coming from. If the quadruples are coming from R then 1's will occur with probability ½ and 0's with probability ½. The adversary will only be correct half the time, as it has no advantage. If the quadruples come from D then the adversary has an advantage and 1's will occur with probability ½+α (where a is the adversary's non-negligible advantage) and 0's with probability ½−α.

Hence, by observation of the output distribution, one has a statistical test for the DDHP.

3.6 IND-CCA2 Security for the Full Scheme

Theorem 2—If the Diffie-Hellman Decision Problem is hard in the group G, then the scheme is secure against an adaptive chosen ciphertext attack.

First the simulator is described. On input the DDH quadruple (g₁, g₂, u₁, u₂) the simulator randomly chooses two private keys z₁, z₂∈Zₖ and outputs the public key as h=g₁^{z}^{₁}g₂^{z}^{₂}.

The simulator simulates the encryption oracle as follows. On input two messages m₀ and m₁ it selects a random bit b∈[0, 1], a random number j∈_{R} Zₖ and computes:

e=(u₁^{z}^{₁}u₂^{z}^{₂}) ·π(m_{b}, j, H(m, j, u₁, u₂))

The simulated encryption oracle outputs the ciphertext (u₁, u₂, e).

The simulated decryption oracle simulates the decryption algorithm as follows. On input (u₁, u₂, e) it computes:

$$M = \frac{e}{( {u}_{1}^{{z}_{1}} {u}_{2}^{{z}_{2}} )}$$

m, j, t=π⁻¹(M)

If H(m, j, u₁, u₂)=t the simulated decryption oracle outputs m, else it outputs Ø.

The aim now is to show that when the input comes from D the simulator simulates the encryption and decryption oracles perfectly (probabilistically) and the advantage of the adversary is apparent at the distinguisher. Alternatively, if the input comes from R then the aim is to show that the adversary can have no advantage in guessing b.

The theorem follows from the following two lemmas.

Lemma 1—When the simulator's input comes from D, the simulator simulates the encryption and decryption oracles perfectly.

The output of the simulated encryption oracle is exactly the same as the output of the real decryption oracle as u₁^{z}^{₁}u₂^{z}^{₂}=g₁^{rz}^{₁}g₂^{rz}^{₂}=(g₁^{z}^{₁}g₂^{z}^{₂})^{r}=h^{r} and so the ephemeral key is the same for both oracles.

If the simulated encryption oracle produces an indistinguishable output from the actual encryption oracle (true since the ephemeral key has the right form and otherwise the simulation is identical in computation to the real oracle), and the simulated decryption oracle behaves in the exactly same way as the actual decryption oracle (they are also identical), then the adversary's view is indistinguishable from their view in an actual attack.

Lemma 2—When the simulator's input comes from R, the distribution of the hidden bit is (essentially) independent from the adversary's view.

When the quadruple comes from R we have u₁=g₁^{r}^{₁} and u₂=g₂^{r}^{₂}. We will show that the adversary's view is independent of the hidden bit b by showing that if no information about the secret keys is leaked, then the challenge ciphertext is equally likely to be the encryption of m₀ or m₁, or in fact any message.

Assuming the simulated decryption oracle only decrypts valid ciphertexts, we now show that no information about the secret keys is leaked by a valid ciphertext. Consider the following equations from the public key and a valid ciphertext.

log h=z₁+wz₂

log ε=r log h=rz₁+rwz₂

Where g₂=g₁^{w} and log refers to log_{g}_{₁}. Clearly they are linearly dependant and leak no information about z₁ or z₂.

Now consider the output of the simulated encryption oracle, here we derive the following equation.

log ε=r₁z₁+r₂wz₂

We can arrange this and the public key equation as a set of linear equations.

$$( \begin{matrix}1 & w \\ {r}_{1} & {wr}_{2}\end{matrix} ) ( \begin{matrix}{z}_{1} \\ {z}_{2}\end{matrix} ) = ( \begin{matrix}log h \\ log ϵ\end{matrix} )$$

The determinant of the matrix is non-zero w(r₂−r₁)≠0, and so these equations have a solution z₁ and z₂ for any e, making its possible values a permutation on G.

This means ε hides M_{b}, as for every possible M_{b} there is an e consistent with e (e is fixed), and that ε can be constructed from a pair of secret keys z₁ and z₂ that are consistent with the public key.

Hence there exists an ε that decrypts the challenge ciphertext e to any M. M could be any element of the group, but in fact it may be invalid in the sense of not satisfying M=π(m, j, t) for any possible m, j and t, or if it satisfies M=π(m, j, t) for some m, j and t then the relation t=H(m, j, u₁, u₂) may not be satisfied. The probability of choosing an ε that decrypts e to an invalid M depends on π(•), and we can say without loss of generality that for all ‘good’ choices of π(•) (see section 2 for a suggestion), the probability that an adversary guesses a correct e is O(2^{|j|})/q, as there will be O(2^{|j|}) valid M for a specific message. If, for example, π(•) performed a one-to-one mapping from its input to group elements then (for the IND-CCA2 game) there would be 2^{|j|+1} valid Mrs. For an appropriate |j| it is a computationally infeasible problem to guess a correct ε. Importantly, all messages have 2^{|j|} valid M's, hence an adversary has an equal chance of finding an c that gives a valid M for any message, and specifically an equal chance of finding an M giving m₀ or m₁, and so the adversary can have no advantage in distinguishing between them.

The above argument relies on the simulated decryption oracle rejecting all invalid ciphertexts; otherwise information about z₁ and z₂ may be leaked. Let a valid ciphertext be (u₁, u₂, e), and an invalid one be (u₁′, u₂′, e′). We consider possibly ciphertexts submitted to the simulated decryption oracle.

1) (u₁′, u₂′, e). If u₁ or u₂ (or any combination thereof) is changed, then if the resulting ciphertext was decrypted by the simulated decryption oracle this would violate the collision property of the universal one-way hash function. If the universal one-way hash function was chosen at random then there is only a negligible chance (in the size of the output of the hash) that a collision can be found (see section 3.4).

2) (u₁, u₂, e′). The ephemeral key depends only on u₁ and u₂, and we know these are unchanged, so the same ephemeral key as was used to encrypt will be calculated by the simulated decryption oracle. When e′ is divided by the ephemeral key, a multiple of M will be the result, call it aM. An upper bound on the number of possible valid M's is 2^{|m|+|j|}, α is chosen from the group, which has size q, which upper bounds the probability an adversary can guess an α that creates a valid M (with a message that is more than likely unrelated to m_{b}) as 2^{|m|+|j|}/q. If these parameters are chosen correctly this probability is negligible.

The adversary will attempt to do better than just guessing. However, without knowing j an adversary cannot hope to reproduce or modify e to e′ in any way better than guessing, to cause the simulated decryption to decrypt e′.

3) (u₁′, u₂′, e′). This case is similar to case 2). Now (essentially) any e′ is valid as long as u₁′ and u₂′ cause the hash check to pass, but this represents a worse probability of success than case 2) as with the lack of any other information the probability of success is 1/q².

Thus, the simulated decryption oracle will reject all invalid ciphertexts, except with negligible probability.

Hence if the DDHP is a computationally unfeasible problem then an IND-CCA2′ attacker for the fill scheme cannot exist.

4 Conclusion

A new scheme was created which was shown to be provably secure against an IND-CCA2 adversary. The advantage of this new scheme is that it is roughly twice as efficient as CS in terms of computational overhead and has similar communication overhead, and that its proof relies only on standard intractability assumptions (it does not require the RO assumption).

1. A public key encryption scheme using a private key, z, and a public key, h, comprises the encryption of a message, m, within a ciphertext, wherein an element of the encrypted ciphertext containing the message is formed by a message product of a variable, ε, based on the public key, h, and an output of an invertible deterministic method, π, operated on at least the message, m, and a hash, H, of at least the message.

2. A public key encryption scheme as claimed in claim 1, wherein the ciphertext includes at least one random element, u₁.

3. A public key encryption scheme as claimed in claim 1, wherein the invertible deterministic method is operated on the message, m, an index, j, of the hash and a hash, H, over both the message, m, and at least one random element, u₁.

4. A public key encryption scheme as claimed in claim 1, wherein the variable, ε, based on the public key is the public key, h, raised to the power of a random number, r.

5. A public key encryption scheme as claimed in claim 1, wherein the ciphertext is decrypted using a private key, z, the at least one random element u₁, the message product, and the invertible deterministic method, π.

6. A public key encryption scheme as claimed in claim 1, wherein the invertible deterministic method, π, is operated on a check for the decryption.

7. A public key encryption scheme as claimed in claim 6, wherein, the hash, H, for the check is over the message and at least one random element, u₁.

8. A public key encryption scheme as claimed in claim 1, wherein the message product is represented by ε.M, where ε=h^{r} (r is random) and h=g^{z}, where g₁ is a first generator, z is a randomly chosen private key and M=π(m, j, t) where π is the invertible deterministic method, m is the message, j is a random index of the hash and t=Hⱼ (m, g₁^{r}, g₂^{r}), where Hⱼ is the j^{th} hash and g₂ is a second generator.

9. A public key encryption scheme as claimed in claim 1, wherein the ciphertext includes said at least one random element, u₁.

10. A public key encryption scheme as claimed in claim 1, wherein at least one of said random elements, u₁, is used to decipher the ciphertext, in conjunction with the private key, z, to determine the output, M, of the invertible deterministic method, π, which output is then inverted to give an original input and hence the message, m.

11. A public key encryption/decryption method makes use of a ciphertext that includes a check element, t, wherein a check made during decryption is a hash, H, over at least the encrypted message, m.

12. A public key encryption/decryption method as claimed in claim 11, wherein the hash, H, is over the message, m, and at least one random element, u₁.

13. A public key encryption method includes creating a ciphertext requiring at most 4 exponentiations to encrypt, including exponentiations for each of at least two random elements, u₁, u₂ and an exponentiation for a public key, h, wherein a message for encryption does not require an exponentiation to encrypt.

14. A public key encryption method as claimed in claim 13, wherein the method includes 3 exponentiations, being for a first random element, u₁, a second random element, u₂, and for the public key, h.

15. A public key encryption/decryption method includes decrypting a ciphertext with at most 2 exponentiations, including an exponentiation using a private key, z, to allow recovery of an encrypted message, m.

16. A public key encryption/decryption method as claimed in claim 15, wherein only one exponentiation is required.

17. A public key encryption/decryption method involves creating a ciphertext and. decrypting the ciphertext, in which a public key requires no more than 3 group elements and a private key requires no more than one group element, whilst still providing a provably secure method.
